(19) United States
(12) Patent Application Publication
(10) Pub. No.: US 2025/0166351 A1
(43) Pub. Date: May 22, 2025

(54) Method and Device for Produce Recommendations Using an External Computing Apparatus

(71) Applicant: Zebra Technologies Corporation, Lincolnshire, IL (US)

(72) Inventor: Mehaboob Kumbalakkuzhiyil, Holbrook, NY (US)

(21) Appl. No.: 18/516,869

(22) Filed: Nov. 21, 2023

(51) Int. Cl. G06V 10/764; G01G 19/415; G07G 1/00

(52) U.S. Cl. CPC G06V 10/764; G01G 19/415; G07G 1/0045

(57) ABSTRACT

Methods and device for produce recommendations using an external computing apparatus are disclosed herein. A data capture device may include an imaging assembly and a prediction controller connected to a host device. The data capture device may be configured to: capture images of an object in one or more fields of view, provide generated image data associated with the images to an object prediction application deployed on the prediction controller, identify, via the object prediction application, one or more aspects of the object, generate, via the object prediction application, object candidate data corresponding to the object from the identification, generate object identifier data for each object candidate in the object candidate data, and/or transmit the object candidate data and/or the object identifier data to the host device over a scanner terminal of the host device.

### BACKGROUND

Conventional data capturing systems (e.g., a combination of a data capture device and a host device) are not typically bi-directional in terms of the flow and processing of data. For example, in most conventional systems, a data capture device may capture an image, process the image (e.g., decode barcode data visible in the image), and then transmit the processed data to the host device. Once transmitted, the data capture device cannot further process the data. As a result, conventional data capturing systems often struggle in identifying objects that do not have easily decodable information (such as a barcode).

For example, if an object does not include an indicia (e.g., a barcode)—such as produce, meat, etc. —the object is typically processed using object identifying applications before being transmitted to the host device. However, a common limitation of such conventional configurations is that host devices are often not configured to read the output from these object identifying applications. As such, the output of these object identifying application cannot inform the host device the identity of the object placed before data capture devices. Thus, users of the host device must navigate through a full listing of products to identify the object manually, rendering the object identifying application moot.

### SUMMARY

In another embodiment, the present invention may be a data capture device comprising: (1) an imaging assembly configured to capture images over one or more fields of view; (2) one or more processors connected to the imaging assembly; (3) one or more memories communicatively coupled to the one or more processors; and/or (4) computing instructions stored on the one or more memories that, when executed, may cause the data capture device to: capture, via the imaging assembly, images of an object in one or more fields of view, wherein the data capture device decodes indicia on objects in image data and the data capture device transmits the decoded indicia data to a host device over a scanner terminal of the host device, in response to being unable to identify a decodable indicia on the object, provide generated image data associated with the images to an object prediction application deployed on the one or more memories, identify, via the object prediction application, one or more aspects of the object, generate, via the object prediction application, object candidate data corresponding to the object from the identification, wherein the object prediction application is deployed on the one or more memories and the object prediction application is configured to generate object candidate data corresponding to one or more objects detected within captured images, generate object identifier data for each object candidate in the object candidate data, and/or transmit one or more of (i) the object candidate data or (ii) the object identifier data to the host device over the scanner terminal of the host device.

Additionally or alternatively, in some embodiments, the data capture device may further include an electronic weight scale connected to the imaging assembly. The electronic weight scale may be configured to detect, via the electronic weight scale, a change in weight of a display area. Additionally or alternatively, in some embodiments, the images may be captured in response to the electronic weight scale detecting the change in weight, and the imaging assembly has a field of view of the display area.

Additionally or alternatively, in some embodiments, the object prediction application may be further configured to: (i) generate a confidence score for each object candidate in the object candidate data, (ii) determine a greatest confidence score exceeds a second greatest confidence score by a threshold amount, and/or (iii) generate determined object candidate data corresponding to the object candidate with the greatest confidence score, wherein object identifier data of the determined object candidate data is generated and the object identifier data of the determined object candidate data is transmitted to the host device.

Additionally or alternatively, in some embodiments, a combination of the one or more processors and the one or more memories is separately housed from the imaging assembly and/or the imaging assembly is communicatively connected to the host device via the scanner terminal.

Additionally or alternatively, in some embodiments, a combination of the one or more processors and the one or more memories is separately housed from the imaging assembly and/or the combination of the one or more processors and the one or more memories is communicatively connected to the host device via the scanner terminal.

Additionally or alternatively, in some embodiments, the imaging assembly is housed in a same housing as the one or more processors and the one or more memories and/or the data capture device is communicatively connected to the host device via the scanner terminal.

In a further embodiment, the present invention may be a computer-readable method may include: (1) capturing, via an imaging assembly, images of an object in one or more fields of view, wherein a data capture device decodes indicia on objects in image data and the data capture device transmits decoded indicia data to a host device over a scanner terminal of the host device; (2) in response to the data capture device being unable to identify a decodable indicia on the object, providing, via one or more processors of the data capture device, generated image data associated with the images to an object prediction application deployed on one or more memories of the data capture device; (3) identifying, via the object prediction application, one or more aspects of the object; (4) generating, via the object prediction application, object candidate data corresponding to the object from the identification, wherein the object prediction application is configured to generate object candidate data corresponding to one or more objects detected within captured images; (5) generating, via the data capture device, object identifier data for each object candidate in the object candidate data; and/or (6) transmitting, via the data capture device, one or more of (i) the object candidate data or (ii) the object identifier data to a host device over the scanner terminal of the host device.

Additionally or alternatively, in some embodiments, the method may further include: detecting, via an electronic weight scale connected to the imaging assembly, a change in weight of a display area. In some embodiments, the images may be captured in response to the electronic weight scale detecting the change in weight, and the imaging assembly has a field of view of the display area.

Additionally or alternatively, in some embodiments, the object prediction application may be further configured to: (i) generate a confidence score for each object candidate in the object candidate data, (ii) determine a greatest confidence score exceeds a second greatest confidence score by a threshold amount, and/or (iii) generate determined object candidate data corresponding to the object candidate with the greatest confidence score, wherein an object identifier of the determined object candidate data is generated and the object identifier of the determined object candidate data is transmitted to the host device.

Additionally or alternatively, in some embodiments, the one or more memories are communicatively coupled to the one or more processors, the one or more processors are connected to the imaging assembly, a combination of the one or more processors and the one or more memories is separately housed from the imaging assembly, and/or the imaging assembly is communicatively connected to the host device via the scanner terminal.

Additionally or alternatively, in some embodiments, the one or more memories are communicatively coupled to the one or more processors, the one or more processors are connected to the imaging assembly, a combination of the one or more processors and the one or more memories is separately housed from the imaging assembly, and/or the combination of the one or more processors and the one or more memories is communicatively connected to the host device via the scanner terminal.

Additionally or alternatively, in some embodiments, the one or more memories are communicatively coupled to the one or more processors, the one or more processors are connected to the imaging assembly, a data capture device comprises a combination of the one or more memories, the one or more processors and the imaging assembly, the imaging assembly is housed in a same housing as the one or more processors and the one or more memories, and/or the data capture device is communicatively connected to the host device via the scanner terminal.

In yet another embodiment, the present invention may be a tangible, non-transitory computer-readable medium storing instructions that, when executed by one or more processors of a data capture device, may cause the data capture device to: (1) capture, via the imaging assembly, images of an object in one or more fields of view, wherein the data capture device decodes indicia on objects in image data and the data capture device transmits the decoded indicia data to a host device over a scanner terminal of the host device; (2) in response to being unable to identify a decodable indicia on the object, provide generated image data associated with the images to an object prediction application deployed on the one or more memories; (3) identify, via the object prediction application, one or more aspects of the object; (4) generate, via the object prediction application, object candidate data corresponding to the object from the identification, wherein the object prediction application is deployed on the one or more memories and the object prediction application is configured to generate object candidate data corresponding to one or more objects detected within captured images; (5) generate object identifier data for each object candidate in the object candidate data; and/or (6) transmit one or more of (i) the object candidate data or (ii) the object identifier data to the host device over the scanner terminal of the host device.

Additionally or alternatively, in some embodiments, an electronic weight scale may be connected to the data capture device and the stored instructions may further cause the data capture device to detect, via an electronic weight scale connected to the imaging assembly, a change in weight of a display area. Additionally or alternatively, in some embodiments, the images may be captured in response to the electronic weight scale detecting the change in weight, and the imaging assembly has a field of view of the display area.

Additionally or alternatively, in some embodiments, the object prediction application may be further configured to: (i) generate a confidence score for each object candidate in the object candidate data, (ii) determine a greatest confidence score exceeds a second greatest confidence score by a threshold amount, and/or (iii) generate determined object candidate data corresponding to the object candidate with the greatest confidence score, wherein an object identifier of the determined object candidate data is generated and the object identifier of the determined object candidate data is transmitted to the host device.

Additionally or alternatively, in some embodiments, the one or more processors are connected to the imaging assembly, a combination of the one or more processors and the tangible, non-transitory computer-readable medium is separately housed from the imaging assembly, and/or the imaging assembly is communicatively connected to the host device via the scanner terminal.

Additionally or alternatively, in some embodiments, the one or more processors are connected to the imaging assembly, a combination of the one or more processors and the tangible, non-transitory computer-readable medium is separately housed from the imaging assembly, and/or the combination of the one or more processors and the tangible, non-transitory computer-readable medium is communicatively connected to the host device via the scanner terminal.

Additionally or alternatively, in some embodiments, the one or more processors are connected to the imaging assembly, a data capture device comprises a combination of the tangible, non-transitory computer-readable medium, the one or more processors and the imaging assembly, the imaging assembly is housed in a same housing as the one or more processors and the tangible, non-transitory computer-readable medium, and/or the data capture device is communicatively connected to the host device via the scanner terminal.

Advantages will become more apparent to those of ordinary skill in the art from the following description of the preferred embodiments, which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates an example computing environment for implementing the systems, devices, and methods described herein;

FIG. 2 illustrates an example implementation of the computing systems, devices, and methods described herein;

FIG. 3A is an example graphical user interface of a register log application;

FIG. 3B is another example graphical user interface of a register log application;

FIG. 3C is yet another example graphical user interface of a register log application; and

FIG. 4 is a block diagram of an example flowchart for an example method and/or operation described herein.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Conventional image-based data capture devices may include image devices (such as a scanner) connected to a host device (such as a point-of-sale (POS) terminal). The imaging device may scan an indicia (such as a barcode) located on an object and the decoded information from the indicia identifying the object may then be transmitted to the host device. Upon receiving the decoded information, the host device may accurately identify the object and use this information in a POS transaction. While these conventional configurations work well for objects featuring indicia, as noted above, these conventional configurations tend to fail if the object is not featuring an indicia because the host device is often not configured to read the output of object identifying applications

The present disclosure relates generally to an imaging-based data capture device that may be connected to a host device that processes POS transactions. In particular, the methods and systems described herein address the limitations of conventional operations by allowing host devices to read the outputs of object identifying applications (e.g., in scenarios where an object does not have a barcode) without having to be specifically configured to read those outputs. In this way, software associated with the data capture device may be able to subsequently process data transmitted to the host device to allow for fast and accurate object identification without an easily decodable indicia.

The data capture device may include an imaging assembly and/or a prediction controller. In some embodiments, the imaging assembly and the prediction controller may be enclosed in a singular housing and/or share components (e.g., processing elements, memories, etc.). A user may place an object in the field of view of the imaging assembly, and the imaging assembly may capture one or more images of the object. In some embodiments, the images may then be processed, analyzed, and/or embedded to generate image data associated with the captured images. For example, the image data may include a highly contrasted version of an image and/or the image data may include meta data included with the image (e.g., decoded indicia data). The images and/or the image data may then be input into an object prediction application wherein one or more object candidates are generated. The data capture device may convert the one or more object candidates into one or more object identifiers (e.g., product look up (PLU) codes) readable by the host device. The data capture device may then pass the one or more object candidates to the host device.

In this way, the systems described herein overcome the limitations of conventional product identification systems because host devices may now be able to identify objects from the outputs of object prediction applications without the need for the specific configuration of reading those outputs.

As used herein, the term indicia should be understood to refer to any kind of visual marker that can be associated with an object. For example, indicia can be a 1D, 2D, or 3D barcode, a graphic, a logo, etc. Additionally, indicia may comprise encoded payload data as, for example, is the case with a 1D or 2D barcode where the barcode encodes a payload comprised of, for example, alphanumeric or special characters that may be formed into a string.

### Computing Environments

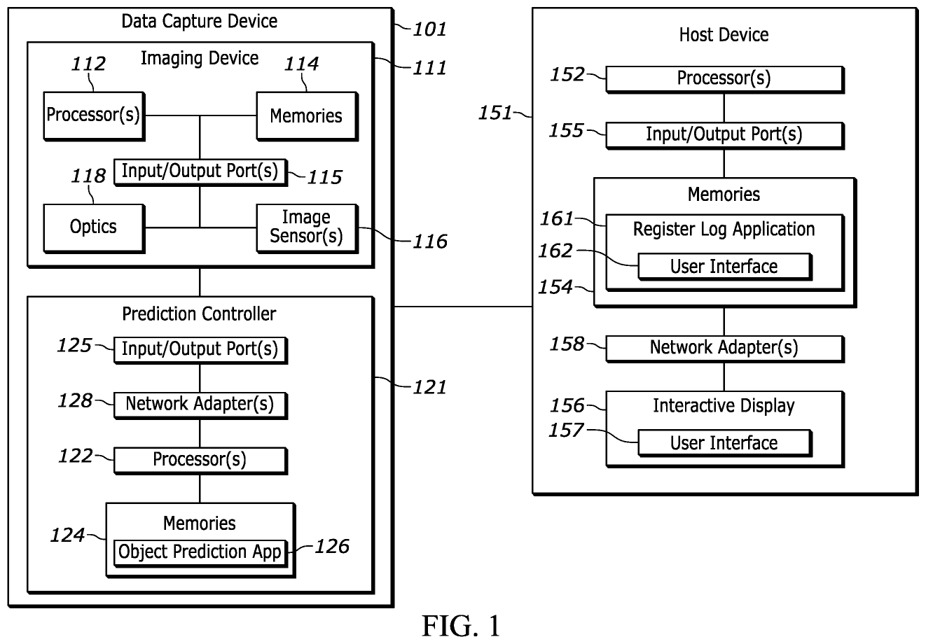

FIG. 1 illustrates an example computing environments for implementing systems, devices, and methods described herein. The example computing environments may include a data capture device 101 and/or a host device 151.

The data capture device 101 may include an imaging device 111 and/or a prediction controller 121.

The imaging device 111 may include one or more processors 112, one or more memories 114, one or more I/O ports 115, one or more image sensors 116, and/or one or more optics 118. Any of these components of the imaging device 111 may be communicatively coupled to one another via a dedicated communication bus. In one example, the imaging device 111 may be a camera device. In another example, the imaging device 111 may be a scanning device (such as a monoptic scanner, a bioptic scanner, etc.).

The one or more processors 112 may be one or more central processing units (CPUs), one or more coprocessors, one or more microprocessors, one or more graphical processing units (GPUs), one or more digital signal processors (DSPs), one or more application specific integrated circuits (ASICs), one or more programmable logic devices (PLDs), one or more field-programmable gate arrays (FPGAs), one or more field-programmable logic devices (FPLDs), one or more microcontroller units (MCUs), one or more hardware accelerators, one or more special-purpose computer chips, and one or more system-on-a-chip (SoC) devices, etc.

The one or more memories 114 may be any local short term memory (e.g., random access memory (RAM), read only memory (ROM), cache, etc.) and/or any long term memory (e.g., hard disk drives (HDD), solid state drives (SSD), etc.). The one or more memories 114 may also store machine readable instructions, including any of one or more application(s) and/or one or more software component(s) which may be implemented to facilitate or perform the features, functions, or other disclosure described herein, such as any methods, processes, elements or limitations, as illustrated, depicted, and/or described for the various flowcharts, illustrations, diagrams, figures, and/or other disclosure herein.

As an example, the machine readable instructions of the imaging device 111 may instruct, direct, and/or cause the imaging device 111 to capture images over one or more fields of view (FOVs). As an example, the machine readable instructions of the imaging device 111 may instruct, direct, and/or cause the imaging device 111 and/or any processors of the data capture device 101 to decode encrypted information within images and/or image data, such as indicia (e.g., barcodes, quick-response (QR) codes, etc.).

The one or more processors 112 may include one or more registers capable of temporarily storing data, and the one or more processors 112 may include further storage capacity in the form of integrated memory slots. The one or more processors 112 may interact with the any of the forgoing (e.g., registers, integrated memory slots, one or more memories 114, etc.) to obtain, for example, machine-readable instructions corresponding to, for example, the operations represented by the flowcharts of this disclosure.

The one or more I/O ports 115 may be, or may include, any number of different types of I/O units, I/O interfaces, and/or I/O circuits that enable the one or more processors 112 of the imaging device 111 to communicate with external devices (e.g., one or more I/O ports 125 of the prediction controller 121 and/or one or more I/O ports 155 of the host device 151). In some embodiments, the one or more I/O ports 115 of the imaging device 111 may have a direct connection to the one or more I/O ports 125 of the prediction controller 121 (e.g., via dedicated coupling via a communication bus, a wired connection, a wireless connection, etc.) to allow for the imaging device 111 to receive digital signals, object candidate data, and/or object identifier data from the prediction controller 121 and/or transmit images and/or image data to the prediction controller 121. Additionally or alternatively, in some embodiments, the one or more I/O ports 115 of the imaging device 111 may also have a direct connection to the one or more I/O ports 155 of the host device 151 (e.g., via a dedicated scanner terminal, a wireless connection, etc.) to allow for the imaging device 111 to transmit the object candidate data generated by the prediction controller 121 to the host device 151. In some embodiments, the imaging device 111 may also transmit object identifier data to the host device 151.

The one or more image sensors 116 may be any image capturing unit(s), component(s), and/or sensor capable(s) of capturing images. For example, the image sensors 116 may be CMOS image sensors, CCD image sensors, and/or other types of image sensor architectures. The image sensors 116 may be configured to capture convert the values of the component sensors into a file format associated with images.

The one or more optics 118 may be any optical elements, such as collimators, lenses, apertures, compartment walls, etc. that may be attached to and/or detached from a housing of the imaging device 111.

In operation, the imaging device 111 may be configured to capture images and/or decode indicia data in the images and/or image data. In embodiments where two or more imaging devices 111 are employed, the two or more imaging devices may be arranged such that the FOV of each imaging device 111 has a different perspective than the FOV of each other imaging device 111. In some embodiments, the imaging device 111 may capture the image device upon receiving a digital communication signal (e.g., a signal flag triggered by an electronic sensor communicatively coupled to the imaging device 111). In some embodiments, the imaging device 111 may be configured to continuously capture images over a period of time (e.g., a video recording, a video stream, etc.). In these embodiments, a single frame may be selected. In some embodiments, the single frame is selected based upon the quality of the image frame (e.g., using a focus measure operator and/or algorithm as described herein). In these embodiments, the frame with the highest relative quality among the captured frames may be selected.

The imaging device 111 and/or one or more dedicated processors of the data capture device 101 may decode one or more indicia in the images and/or image data. For example, in the embodiments where the object has an indicia visible in the images and/or image data, the imaging device 111 and/or one or more dedicated processors of the data capture device 101 may decode the indicia to generate the decoded indicia data and then transmit the decoded indicia data to the host device 151. Conversely, in the embodiments where the object has no indicia, the indicia is not visible in the images and/or image data, and/or the prediction controller 121 cannot otherwise decode the indicia in the images and/or image data, the imaging device 111 and/or one or more dedicated processors of the data capture device 101 may transmit the images and/or image data to either to the prediction controller 121.

In the embodiments where the imaging device 111 is continuously capturing images over a period of time, the imaging device 111 may decode the images and/or image data and/or transmit the images, image data, and/or decoded indicia data in parallel to capturing the images (e.g., transmitting 24 image frames every second, transmitting a stream of image frames as soon as it is captured, etc.).

The prediction controller 121 may include one or more processors 122, one or more memories 124, one or more input and/or output (I/O) ports 125, and/or one or more network adapters 128. Any of these components of the prediction controller 121 may be communicatively coupled to one another via a dedicated communication bus.

The one or more processors 122 may be one or more central processing units (CPUs), one or more coprocessors, one or more microprocessors, one or more graphical processing units (GPUs), one or more digital signal processors (DSPs), one or more application specific integrated circuits (ASICs), one or more programmable logic devices (PLDs), one or more field-programmable gate arrays (FPGAs), one or more field-programmable logic devices (FPLDs), one or more microcontroller units (MCUs), one or more hardware accelerators, one or more special-purpose computer chips, and one or more system-on-a-chip (SoC) devices, etc.

The one or more memories 124 may be any local short term memory (e.g., random access memory (RAM), read only memory (ROM), cache, etc.) and/or any long term memory (e.g., hard disk drives (HDD), solid state drives (SSD), etc.). The one or more memories 124 may also store machine readable instructions, including any of one or more application(s) and/or one or more software component(s) which may be implemented to facilitate or perform the features, functions, or other disclosure described herein, such as any methods, processes, elements or limitations, as illustrated, depicted, and/or described for the various flowcharts, illustrations, diagrams, figures, and/or other disclosure herein.

As another example, the machine readable instructions of the prediction controller 121 may include an object prediction application 126 configured to: (i) receive images and/or image data captured by the imaging device 111, (ii) identify one or more aspects of an object in the images and/or image data, and/or (iii) generate object candidate data corresponding to the object from the identification. In some embodiments, the object candidate data includes a classification, categorization, designation or otherwise determination regarding the identity of the object (e.g., a designation of that an object is a banana). Additionally, in some embodiments, the object candidate data may include be one or more product look up (PLU) codes.

As yet another example, the machine readable instructions of the prediction controller 121 may instruct, direct, and/or cause the prediction controller 121 to convert the generated object candidate data into object identifier data. In these embodiments, the conversion may involve converting the PLU code of the object candidate data (as assigned by the data capture device 101) into the PLU code of the register log application 161 and/or the host device 151.

As a further example, the machine readable instructions of the prediction controller 121 may instruct, direct, and/or cause the prediction controller 121 to transmit the object identifier data to the host device 151. In these embodiments, the prediction controller 121 may also transmit object identifier data to the host device 151. The machine readable instructions of the prediction controller 121 may also instruct, direct, and/or cause the host device 151 to facilitate and/or perform the features, functions, or other disclosure described herein.

The one or more processors 122 may include one or more registers capable of temporarily storing data, and the one or more processors 122 may include further storage capacity in the form of integrated memory slots. The one or more processors 122 may interact with the any of the forgoing (e.g., registers, integrated memory slots, one or more memories 124, etc.) to obtain, for example, machine-readable instructions corresponding to, for example, the operations represented by the flowcharts of this disclosure.

The one or more I/O ports 125 may be, or may include, any number of different types of I/O units, I/O interfaces, and/or I/O circuits that enable the one or more processors 122 of the prediction controller 121 to communicate with external devices (e.g., one or more I/O ports 115 of the imaging device 111 and/or one or more I/O ports 155 of the host device 151). In some embodiments, the one or more I/O ports 125 of the prediction controller 121 may have a direct connection to the one or more I/O ports 115 of the imaging device 111 (e.g., via dedicated coupling via a communication bus, a wired connection, a wireless connection, etc.) to allow for the prediction controller 121 to receive images and/or image data from and/or transmit object candidate data and/or object identifier data to the imaging device 111. Additionally or alternatively, in some embodiments, the one or more I/O ports 125 of the prediction controller 121 may have a direct connection to the one or more I/O ports 155 of the host device 151 (e.g., via a wired connection, such as a universal serial bus (USB) or ethernet connection, a wireless connection, etc.) to allow for the prediction controller 121 to transmit object identifier data to the host device 151.

The one or more network adapters 128 may include be one or more communication components configured to communicate (e.g., send and receive) data via one or more external/network port(s) over one or more communication networks. For example, the one or more network adapters 128 may be, or may include, a wired network adapter, connector, interface, etc. (e.g., an Ethernet network connector, an asynchronous transfer mode (ATM) network connector, a digital subscriber line (DSL) modem, a cable modem) and/or a wireless network adapter, connector, interface, etc. (e.g., a Wi-Fi connector, a Bluetooth® connector, an infrared connector, a cellular connector, etc.) configured to communicate over the one or more communication networks. Additionally or alternatively, in various aspects, the one or more network adapters 128 may include, or interact with, one or more transceivers (e.g., WWAN, WLAN, and/or WPAN transceivers) functioning in accordance with IEEE standards, 3GPP standards, or other standards, and that may be used in receipt and transmission of data via external/network ports connected to the one or more communication networks.

In operation, in some embodiments, the prediction controller 121 may be configured to: (i) receive images and/or image data from the imaging device 111, (ii) provide the images and/or image data to the object prediction application 126 to generate object candidate data, (iii) convert the object candidate data into object identifier data, (iv) transmit the object candidate data and/or the object identifier data to the imaging device 111 and/or (v) transmit the object identifier data to the host device 151.

For example, in the embodiments where the object has an indicia visible in the images and/or image data, the prediction controller 121 may not receive the images and/or image data from the imaging device 111, as the indicia may be decoded to generate the decoded indicia data. The generated decoded indicia data may be transmitted by the data capture device 101 (e.g., via the one or more ports 115 of the imaging device 111) to the host device 151. As another example, in the embodiments where the object has no indicia, the indicia is not visible in the images and/or image data, and/or the imaging device 111 and/or one or more dedicated processors of the data capture device 101 cannot otherwise decode the indicia in the images and/or image data, the prediction controller 121 may receive the images and/or image data from the imaging device 111, provide the images and/or image data to the object prediction application 126 to generate object candidate data (e.g., based upon one or more identifying features of the object), and then transmit the object candidate data to either the imaging device 111 or the host device 151. In some embodiments, the prediction controller 121 may be configured to convert the object candidate data into object identifier data (e.g., when the system of the data capture device 101 and the host device 151 are configured to only present a number of object candidates to a user of the host device 151).

The host device 151 may include one or more processors 152, one or more memories 154, one or more I/O ports 154, an interactive display 156, and/or one or more network adapters 158. Any of these components of the host device 151 may be communicatively coupled to one another via a dedicated communication bus.

The one or more processors 152 may be one or more central processing units (CPUs), one or more coprocessors, one or more microprocessors, one or more graphical processing units (GPUs), one or more digital signal processors (DSPs), one or more application specific integrated circuits (ASICs), one or more programmable logic devices (PLDs), one or more field-programmable gate arrays (FPGAs), one or more field-programmable logic devices (FPLDs), one or more microcontroller units (MCUs), one or more hardware accelerators, one or more special-purpose computer chips, and one or more system-on-a-chip (SoC) devices, etc.

The one or more memories 154 may be any local short term memory (e.g., random access memory (RAM), read only memory (ROM), cache, etc.) and/or any long term memory (e.g., hard disk drives (HDD), solid state drives (SSD), etc.). The one or more memories 154 may also store machine readable instructions, including any of one or more application(s) and/or one or more software component(s) which may be implemented to facilitate or perform the features, functions, or other disclosure described herein, such as any methods, processes, elements or limitations, as illustrated, depicted, and/or described for the various flowcharts, illustrations, diagrams, figures, and/or other disclosure herein.

As an example, the machine readable instructions of the host device 151 may instruct, direct and/or cause the host device 151 to receive images, image data, decoded indicia data, and/or object identifier data from the data capture device 101.

As another example, the machine readable instructions of the host device 151 may instruct, direct and/or cause the host device 151 to execute one or more applications, such as a register log application 161. In these examples, the register log application 161 may initially display on the interactive display 156 of the host device 151. The register log application 161 may be configured to receive, process, and/or display (e.g., via an interactive display 156 of the host device 151) object identifier data.

The one or more processors 152 may include one or more registers capable of temporarily storing data, and the one or more processors 152 may include further storage capacity in the form of integrated memory slots. The one or more processors 152 may interact with the any of the forgoing (e.g., registers, integrated memory slots, one or more memories 154, etc.) to obtain, for example, machine-readable instructions corresponding to, for example, the operations represented by the flowcharts of this disclosure.

The one or more I/O ports 155 may be, or may include, any number of different types of I/O units, I/O interfaces, and/or I/O circuits that enable the one or more processors 152 of the host device 151 to communicate with external devices (e.g., the one or more I/O ports 115 of the imaging device 111 and/or the one or more I/O ports 125 of the prediction controller 121). In particular, the one or more I/O ports 155 of the host device 151 may have a direct connection to the one or more I/O ports 115 of the imaging device 111 (e.g., via a USB connection, a wireless connection, etc.) to allow for the host device 151 to receive data from the imaging device 111. Similarly, the one or more I/O ports 155 of the host device 151 may have a direct connection to the one or more I/O ports 125 of the prediction controller 121 (e.g., via a USB connection, ethernet, a wireless connection, etc.) to allow for the host device 151 to receive data from the prediction controller 121.

The interactive display 156 of the host device may be any suitable display unit (e.g., a monitor, etc.) capable of outputting visual data to a user and/or capable of receiving input from a user alone (e.g., via a touch screen) and/or in conjunction with one or more input devices (e.g., a mouse and/or a keyboard).

The one or more network adapters 158 may include be one or more communication components configured to communicate (e.g., send and receive) data via one or more external/network port(s) over one or more communication networks. For example, the one or more network adapters 158 may be, or may include, a wired network adapter, connector, interface, etc. (e.g., an Ethernet network connector, an asynchronous transfer mode (ATM) network connector, a digital subscriber line (DSL) modem, a cable modem) and/or a wireless network adapter, connector, interface, etc. (e.g., a Wi-Fi connector, a Bluetooth® connector, an infrared connector, a cellular connector, etc.) configured to communicate over the one or more communication networks. Additionally or alternatively, in various aspects, the one or more network adapters 158 may include, or interact with, one or more transceivers (e.g., WWAN, WLAN, and/or WPAN transceivers) functioning in accordance with IEEE standards, 3GPP standards, or other standards, and that may be used in receipt and transmission of data via external/network ports connected to the one or more communication networks.

### Machine Learning and Machine Vision Embodiments

The present embodiments may involve the use of machine vision, image recognition, object identification, and/or other image processing techniques and/or algorithms, collectively referred to as machine vision (MV) herein. In particular, images and/or image data may be input into one or more machine vision programs described herein that are able to recognize, track, and/or identify objects and/or specific features of objects (e.g., the bend of a banana, the color of an orange, the outline of an apple, etc.) in and across the images and/or image data. Additionally, such machine vision programs may also be able to analyze the images and/or image data itself to determine the quality of the images and/or image data, select one or more images from a plurality of images and/or image data, and/or the like.

In some embodiments, the MV techniques and/or algorithms may utilize image classification, image recognition, and/or image identification techniques and/or algorithms (e.g., query by image content (QBIC), optical character recognition (OCR), pattern and/or shape recognition, histogram of oriented gradients (HOG) and/or other object detection methods), two dimensional image scanning, three dimensional image scanning, and/or the like. Similarly, the MV techniques and/or algorithms may utilize focus measure operators and/or accompanying algorithms (e.g., gradient-based operators, Laplacian-based operators, wavelet-based operators, statistics-based operators, discrete cosine transform based operators, and/or the like) to determine the focus of the images and/or image data. Such operators and/or algorithms may be applied to the images and/or image data as a whole or to a portion of the images and/or image data. The resulting focus may be a representation of the quality of the images and/or image data. If the focus (and, thus, the quality) of the images and/or image data falls below a threshold value, subsequent images and/or image data may be captured.

In some embodiments, the MV techniques and/or algorithms may utilize machine learning (ML) (also known as artificial intelligence (AI)) techniques and/or algorithms. For instance, a processor and/or a processing element (e.g., the one or more processors 112 of the imaging device 111, the one or more processors 122 of the prediction controller 121 and/or the one or more processors 152 of the host device 151) may be trained, validated, and/or otherwise developed using supervised machine learning to determine one or more object candidate identifications of an object within images and/or image data.

Further, in some embodiments, the ML program may employ one or more artificial neural network, which may be convolutional neural network(s) (CNN), fully convolutional neural network(s) (FCN), deep learning neural network(s), and/or combined learning modules or programs that learn in two or more fields or areas of interest. Machine learning may involve identifying and/or recognizing patterns in existing data in order to facilitate making predictions, estimates, and/or recommendations for subsequent data.

In supervised ML, a processing element identifies patterns in existing data to make predictions and/or classifications about subsequently received data. Specifically, the processing element is trained using training data, which includes example inputs, which may include features and associated labels. The training data is formatted so that the features explain or otherwise statistically correlate to the labels, such that an ML model outputs a prediction or classification corresponding to the label. Based upon the training data, the processing element may generate a predictive function which maps outputs to inputs and may utilize the predictive function to generate outputs based upon data inputs. In this way, the applied ML program, algorithm, and/or technique may determine and/or discover rules, relationships, and/or patterns between the exemplary inputs and the exemplary outputs. The exemplary inputs and exemplary outputs of the training data may include any of the data inputs or outputs described herein. In some embodiments, the processing element may be trained by providing it with a large sample of data with known characteristics or features. For example, as used herein, the features may be characteristics of objects (e.g., color, shape, classification, etc.). The labels, meanwhile, data may include designations of the object (e.g., a banana, an orange, a pork loin, etc.). In such embodiments, the characteristics of objects may be used to train a ML model to classify, categorize, recognize, and/or identify an object.

Supervised ML may also include retraining, relearning, and/or otherwise updating models with new, or different, information, which may include information received, ingested, generated, or otherwise used over time.

In some embodiments, the ML model generate multiple outputs. In these embodiments, the ML model may generate a confidence score for each generated output, where the ML model has been trained to assign a value to the one or more characteristics that bring an output to a specific classification. For example, when shown a novel image of apples, the ML model may be able to give a confidence score of 90 that the objects in the image are apples, a confidence score of 50 that the objects in the image are tomatoes, a confidence score of 10 that the objects in the image are tomatoes are cherries, etc. In some embodiments, the ML model may then select the output with the greatest confidence score to make a singular determination. In some embodiments, if two or more confidence scores are too close to each other in value (e.g., a difference between confidence scores does not exceed a threshold value), then the ML model may not make a selection and present all generated outputs. For example, the ML model generates a confidence score of 90 that the objects in the image are limes and a confidence score of 85 that the objects in the image are lemons, and confidence values need to have a difference of 10 or greater for the ML model to make a determination, the ML model may then present both outputs and their respective confidence values to the user.

### Example Implementations

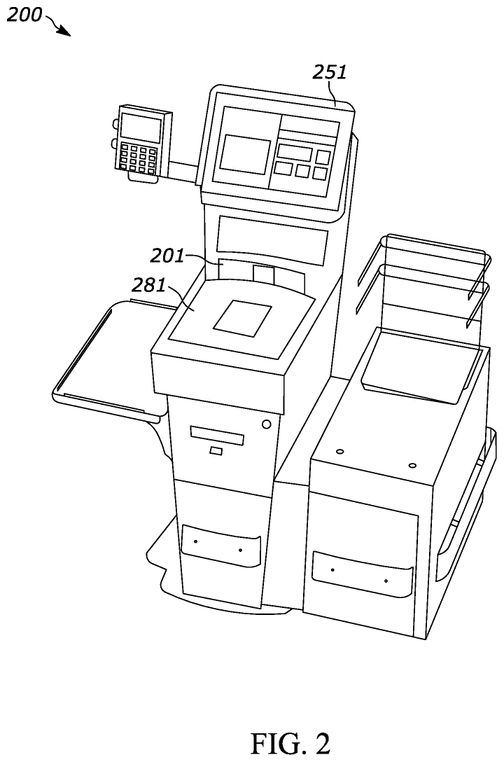

FIG. 2 illustrates an example data capture system 200 for implementing the computing systems, devices, and/or methods described herein. In particular, the data capture system 200 may include a data capture device 201 (e.g., the data capture device 101 as illustrated in FIG. 1), a product presentation region 281, and/or a host device 251 (e.g., the host device 151 as illustrated in FIG. 1).

In the illustrated example, the data capture system 200 is shown as part of a POS system arrangement having the data capture device 201 positioned within a workstation counter. Generally, the data capture device 201 includes an enclosed housing region (also referred to as an upper housing, an upper housing region, an upper housing portion, an upper portion, and/or a tower portion) and a product presentation region 281 (also referred to as a lower housing, a lower housing region, a lower housing portion, a lower portion, and/or a platter portion). The enclosed housing region can be characterized by an optically transmissive window positioned therein along a generally vertical plane and a horizontally extending field of view which passes through a window. The product presentation region 281 can be characterized by an electronic weight scale platter that includes an optically transmissive window positioned therein along a generally horizontal (also referred to as a transverse) plane and a vertically extending field of view which passes through the window. The electronic weight scale platter is a part of a weight platter assembly that generally includes the electronic weight scale platter and a scale (or load cell) configured to measure the weight of an object placed the top surface of the electronic weight scale platter. By that virtue, the top surface of the electronic weight scale platter may be considered to be the top surface of the product presentation region 281 that faces a product scanning region there above.

In operation, a user generally passes an object across a product scanning region of the data capture device 201 in a swiping motion in some general direction relative to the window of the data capture device 201 (e.g., right-to-left). A product scanning region can be generally viewed as a region that extends above the product presentation region 281 and/or in front of the window where data capture device 201 is operable to capture images of sufficient quality to perform imaging-based operations like decoding an indicia that appears in the obtained image. It should be appreciated that while object may be swiped past the data capture device 201 in any direction, items may also be presented into the product scanning region by means other than swiping past the window(s). When the object comes into the any of the fields of view of the data capture device 201, the indicia on the object may be captured and decoded by the data capture device 201, and corresponding data is transmitted to a communicatively coupled host device 151.

The data capture device 201 can utilize a variety of imaging and optical components (collectively referred to as imaging subsystem or imaging assembly) to achieve the desired field of view(s) FOV(s) over which images can be captured and derived data may be transmitted to the host device 151 (such as a decoder (aka decoder subsystem), processor, or ASIC that may be internal to the data capture device 201) for decoding of indicia and further utilization of the decoded payload data. For example, an imaging assembly may include an image sensor(s) (also referred to as an imager or imaging sensor) that can be, for example, a two-dimensional CCD or a CMOS sensor that can be either a monochrome sensor or a color sensor having, for instance 1.2 megapixels arranged in a 1200×960 pixel configuration. It should be appreciated that sensors having other pixel-counts (both below and above) are within the scope of this disclosure. These two-dimensional sensors generally include mutually orthogonal rows and columns of photosensitive pixel elements arranged to form a substantially flat square or rectangular surface. Such imagers are operative to detect light captured by an imaging lens assembly along a respective optical path or axis that normally traverses through either of the generally horizontal or generally upright window(s). In instances where multiple imaging components are used, each respective imager and imaging lens assembly pair is designed to operate together for capturing light scattered, reflected, or emitted from indicia as pixel data over a respective FOV. In other instances, a single imaging sensor may be used to generate a single primary FOV which may be split, divided, and/or folded to generate multiple FOVs by way of splitter and/or fold mirrors. In such cases, data collected from various portions of the imaging sensor may be evaluated as if it was obtained by an individual imaging assembly/imaging sensor.

The host device 251 may include a computing assembly that features an interactive display (such as a desktop computer, a laptop computer, a kiosk computer, a tablet, a smart device, etc.). The computing assembly may work in conjunction with a transceiver, a network adapter, ethernet, and/or one or more connection ports (e.g., a scanning terminal, a USB port, etc.) to communicatively connect with the data capture device 201.

### Graphical User Interfaces

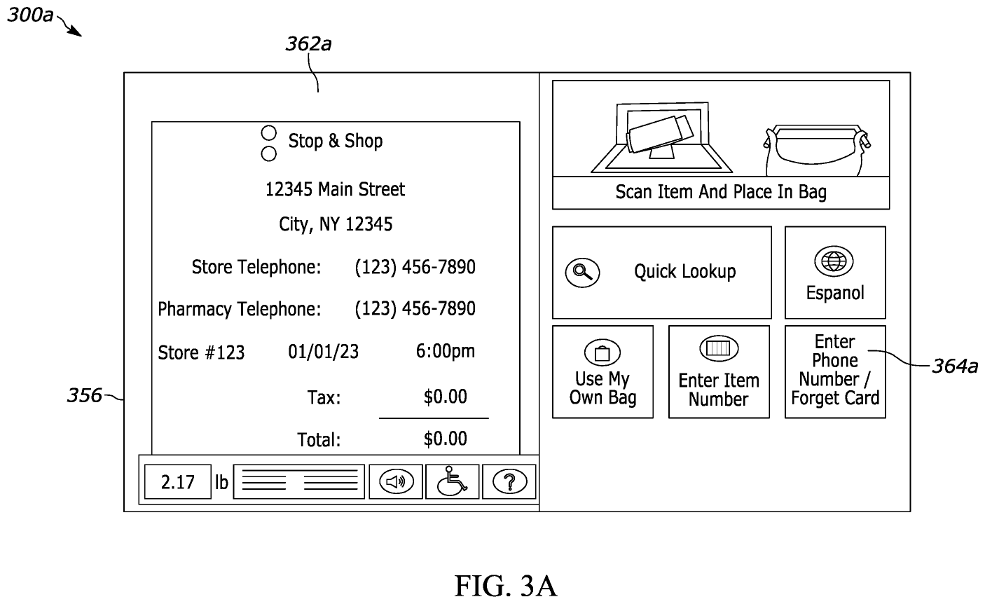

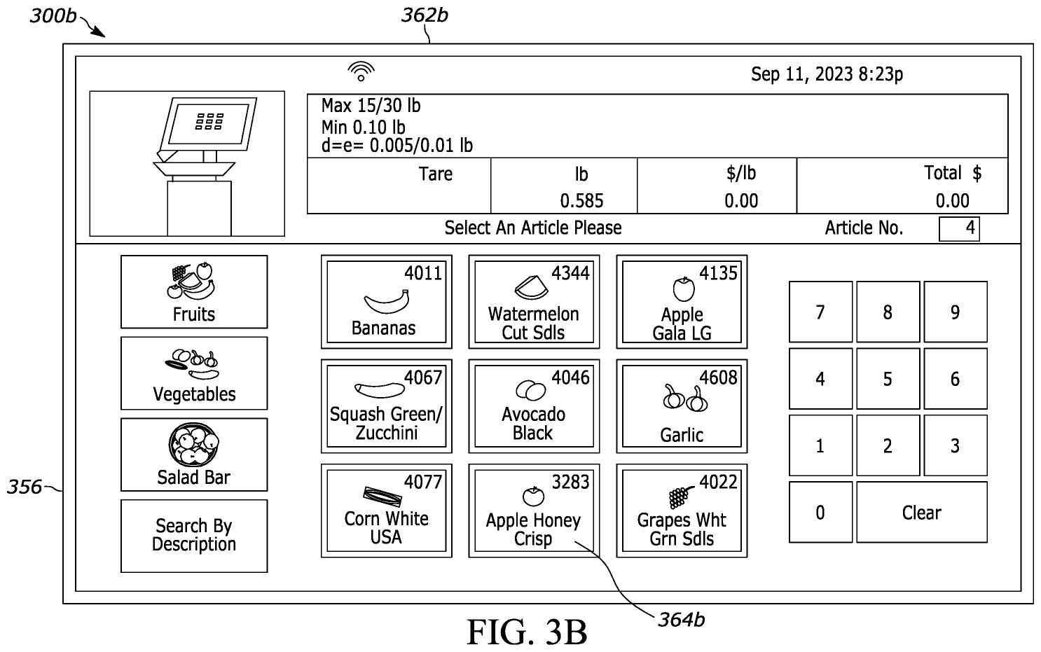

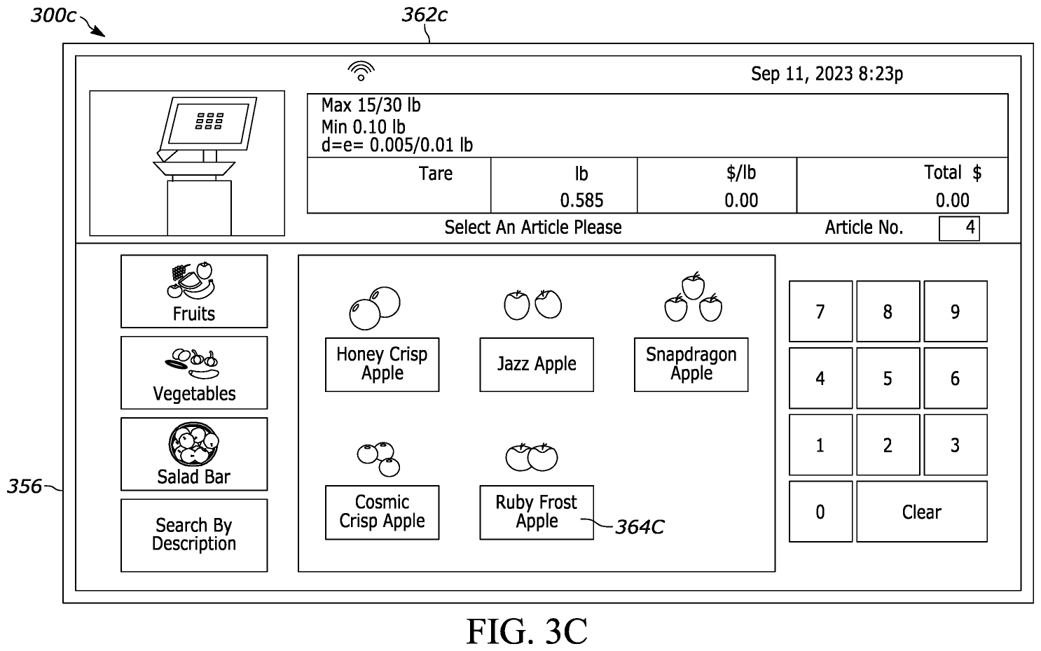

Details of operation of the systems, devices, and methods described herein are provided with respect to FIGS. 3A-3C, which depict example graphical user interfaces (GUIs) that may be displayed on a POS device (e.g., the host device 151 as illustrated in FIG. 1 and/or the host device 251 as illustrated in FIG. 2). Particularly, FIGS. 3A-3C depict example GUIs of a register log application (e.g., the register log application 161 as illustrated in FIG. 1), in accordance with various embodiments. The GUIs of FIGS. 3A-3C may be displayed at the POS device based upon execution of non-transitory computer-executable instructions included in one or more digital application (as described herein) stored at the POS device.

FIG. 3A depicts an example register log GUI 300a via which the POS device may receive decoded indicia and/or PLU codes (e.g., object candidate data and/or object identifier data) from a scanning device (e.g., the data capture device 101 as illustrated in FIG. 1 and/or the data capture device 201 as illustrated in FIG. 2) as well as input from a user. In one embodiment, as illustrated by FIG. 3A, the register log GUI 300a may be displayed in a dedicated register log window 362a, and the register log GUI 300a may include non-interactable text (e.g., the text of “STOP & SHOP,” “Total” as well as corresponding total value of scanned objects, etc.) and/or interactable elements 364a (e.g., the interactable button that features the text of “Quick Lookup,” the interactable button that features the text of “Enter Item Number,” the interactable button that features the text of “Enter Phone Number/Forgot Card,” etc.). As illustrated in FIG. 3A, the register log GUI 300a, may also feature additional GUI elements that may or may not be interactable (e.g., the diagram above the interactable elements 364a illustrating how to scan an object and place it into a bag along with accompanying text).

The user interacting with the interactable elements 364a may cause one or more other GUIs and/or portions of GUIs to be displayed (e.g., interacting with the interactable element button featuring the text “Quick Lookup” may cause the register log GUI 300b as illustrated in FIG. 3B to be displayed), may allow the user to enter input data (e.g., interacting with the interactable element button featuring the text “Quick Lookup” may cause an interactable text box appear to allow the user to enter numerical digits corresponding to the user's phone number), and/or may cause different functionalities of the register log GUI 300a (e.g., interacting with the interactable element button featuring the text “Español” may cause the language of the register log GUI 300a to change from English to Spanish).

FIG. 3B depicts an example register log GUI 300b via which the POS device may receive input data from the user. In one embodiment, as illustrated by FIG. 3B, the register log GUI 300b may be displayed in a dedicated register log window 362b, and the register log GUI 300b may include non-interactable text (e.g., the text of “Select an article please,” “Ib” as well as corresponding weight value of objects placed on the electronic weight scale of the product presentation region 281, etc.) and/or interactable elements 364b (e.g., the interactable button that features the image of an object such as an apple and the text of “Apple Honey Crisp,” the interactable button that features the image of a classification of objects and the text of “Fruits,” the interactable button that features the text of numeric digits, etc.). As illustrated in FIG. 3B, the register log GUI 300a, may also feature additional GUI elements that may or may not be interactable (e.g., the illustration of the scanning device and the POS device at the top left corner of the register log GUI 300b).

A user interacting with the interactable elements 364b may cause one or more other GUIs and/or portions of GUIs to be displayed (e.g., interacting with an interactable element button featuring the text “Back” (not shown) may cause the register log GUI 300a as illustrated in FIG. 3A to be displayed), may allow the user to enter input data (e.g., interacting with the interactable element button featuring the text the text of numeric digits may allow the user to enter numerical digits corresponding to the numerical digit interacted with), and/or may cause different functionalities of the register log GUI 300b (e.g., interacting with the interactable element button featuring the text “Vegetables” may cause a different set of interactable element buttons featuring different objects to be displayed).

In operation, the POS device may receive decoded indicia and/or PLU codes from the scanning device. When the scanning device scans an indicia on an object, the scanning device decodes the indicia and transmits the decoded indicia to the POS device. If the scanning device cannot locate, identify, and/or otherwise decode an indicia relating to the object, the scanning device may utilize an object prediction application (e.g., the object prediction application 126 described herein) to generate one or more PLU codes that may identify the object and/or provide candidates as to what the object might be. Additionally or alternatively, the user may manually enter data to identify an object (e.g., via the user interacting with the interactable input elements 364b of the register log GUI 300b). Upon receiving the decoded indicia data, the PLU codes, and/or the user inputted data, the register log application may add the value corresponding to the identified object to the point of sale transaction.

FIG. 3C depicts an example register log GUI 300c via which the POS device may display one or more object identifiers generated from the scanning device described herein to a user. In one embodiment, as illustrated by FIG. 3C, the register log GUI 300c may be displayed in a dedicated register log window 362c, and the selection GUI 300c may include one or more interactable elements 364c (e.g., the interactable buttons that feature distinct images of apples with accompanying text, etc.). As illustrated in FIG. 3C, the selection GUI 300c, may also feature additional GUI elements at the bottom of the GUI that may or may not be interactable (e.g., the illustration of the scanning device and the POS device at the top left corner of the register log GUI 300c).

The user interacting with the interactable input element 364c may select one or more of the object identifiers to identify the object scanned by the scanning device. In some embodiments, upon selecting one of the object candidates, the register log window 362c may cause another window, GUI, and/or portion of GUIs to be displayed (e.g., the register log GUI 300a as illustrated in FIG. 3A). Additionally or alternatively, in some embodiments, selecting or more of the object identifiers may cause a confirmation alert to appear whereby the user may confirm that the selection accurately identifies the object.

In operation, as described herein, the scanning device, utilizing an object prediction application 126, may generate one or more object candidates of an object in embodiments where the scanning device cannot locate, identify, and/or otherwise decode an indicia relating to an object placed on the product presentation region. The scanning device may convert the one or more object candidates into one or more object identifiers (e.g., by converting the PLU codes to those understood by the POS device) and then transmit the one or more object identifiers to the POS device a scanning terminal. In some embodiments, a scanning driver may be installed on the POS device that manages the receiving functionality of the POS device via the scanning terminal. Upon detecting the one or more object identifiers have been received via the scanning terminal, the scanning driver may then pass the one or more object identifiers to the register log application 162 running on the POS device. In this way, the POS device receives readable PLU codes that it can read and/or process (e.g., using the PLU code to determine a value to include in the transactional total) without having to configure either the register log application 162 or the POS device.

The GUIs depicted in FIGS. 3A-3C are not limited to the aforementioned and/or illustrated exemplary embodiments. For example, while the GUIs depicted in FIGS. 3A-3C are formatted for an electronic device in the form of a kiosk device, the GUIs depicted in FIGS. 3A-3C may be designed for other devices (e.g., desktop and/or laptop computers, mobile phones, smart devices, tablets etc.). Additionally, the layout and/or the elements of the GUIs depicted in FIGS. 3A-3C may include more or less detail, different language, alternative placement of elements, different ordering, and/or the like. Further, the GUIs depicted in FIGS. 3A-3C described herein are not exhaustive, nor should their inclusion be interpreted as a necessary or unnecessary function of the techniques, methods, and systems disclosed herein.

### Methods and Operations

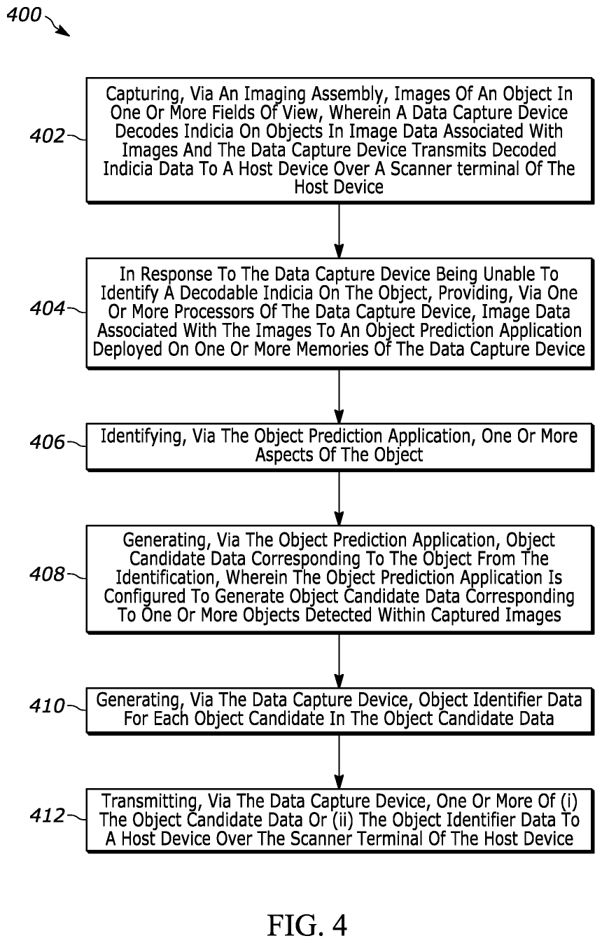

FIG. 4 is a block diagram of an example flowchart for an example method and/or operation 400 described herein. The method and/or operation 400 may employ any of the components, apparatuses, devices, and/or systems described herein with respect to FIG. 1.

The method and/or operation 400 may begin at block 402 by capturing images of an object in one or more fields of view. The capturing of the image data may be performed via an imaging assembly (e.g., the imaging device 111). The imaging assembly may be a component of a data capture device (e.g., the data capture device 101 described herein), the data capture device may decode indicia on objects in image data associated with images, and the data capture device may transmit decoded indicia to a host device (e.g., the host device 151 described herein) over a scanner terminal of the host device.

In some embodiments, the imaging assembly may be communicatively connected a prediction controller (e.g., the prediction controller 121 described herein) and/or the host device (e.g., via the scanning terminal). The prediction controller may be another component of the data capture device. In some embodiments, the imaging assembly and the prediction controller may be combined into a singular housing. In these embodiments, the imaging assembly and the prediction controller may be communicatively coupled via a direct communication bus. Alternatively, in some embodiments, some components of the imaging assembly and the prediction controller may be the same (e.g., the one or more processors 112 of the imaging device 111 and the one or more processors 122 of the prediction controller 121) such that the combination of the imaging assembly and the prediction controller may be considered a singular device. Any of the aforementioned combinations of the imaging assembly and the prediction controller may be considered the data capture device. In some embodiments, the data capture device may be connected to the host device via the scanner terminal.

In some embodiments, the capturing of the image data is continuous. In alternative embodiments, the image data is captured in response to the imaging device 111 receiving a capturing signal in response to a triggered sensor (e.g., a motion sensor, a weight sensor, lidar) and/or a manual triggering of the imaging device 111 (e.g., via a mechanical trigger, button, switch, etc.).

The method and/or operation 400 may proceed to block 404 by providing, via one or more processors of the data capture device, generated image data associated with the images to an object prediction application (e.g., the object prediction application 126 described herein) deployed on one or more memories of the data capture device. This step may be performed in response to the data capture device being unable to locate, identify, and/or otherwise decode a decodable indicia on the object. In the embodiments where the data capture device identifies and/or decodes an indicia on the object, the data capture device does not require an output of the object prediction application to identify the object (e.g., a bar code scan from the imaging assembly can identify the object).

The method and/or operation 400 may proceed to block 406 by identifying, via the object prediction application, one or more aspects of the object. In some embodiments, the object prediction application may include one or more imaging processing algorithms, techniques, and/or models as described herein. Additionally or alternatively, the object prediction application may include one or more machine learning algorithms, techniques, and/or models as described herein.

The method and/or operation 400 may proceed to block 408 by generating, via the object prediction application, object candidate data corresponding to the object from the identification. The object prediction application is configured to generate object candidate data corresponding to one or more objects detected within captured images. In some embodiments, the object candidate data may be one or more product look up (PLU) codes (e.g., corresponding to objects typically without an indicia placed on it, such as produce, meat, etc.).

The method and/or operation 400 may proceed to block 410 by generating, via the data capture device, object identifier data for each object candidate in the object candidate data. In some embodiments, the object identifier data may be a decoded indicia data and/or a product look up (PLU) code associated with and/or readable by an register log application executing on the host device 151. In some embodiments, the PLU code of the object candidate data is converted into a PLU code readable by the register log application to generate the object identifier data.

The method and/or operation 400 may proceed to block 412 by transmitting, via the data capture device, one or more of (i) the object candidate data or (ii) the object identifier data to a host device over the scanner terminal of the host device. The register log application may then receive, process and/or display the object identifier data (e.g., via the user interface).

The method and/or operation 400 may have more or less or different steps and/or may be performed in a different sequence.

### ADDITIONAL CONSIDERATIONS

In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit may include one or more processors 102. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A data capture device comprising:
an imaging assembly configured to capture images over one or more fields of view;
one or more processors connected to the imaging assembly;
one or more memories communicatively coupled to the one or more processors; and
computing instructions stored on the one or more memories that, when executed, cause the data capture device to:
capture, via the imaging assembly, images of an object in one or more fields of view,
wherein the data capture device decodes indicia on objects in image data and the data capture device transmits the decoded indicia data to a host device over a scanner terminal of the host device,
in response to being unable to identify a decodable indicia on the object, provide generated image data associated with the images to an object prediction application deployed on the one or more memories,
identify, via the object prediction application, one or more aspects of the object,
generate, via the object prediction application, object candidate data corresponding to the object from the identification,
wherein the object prediction application is deployed on the one or more memories and the object prediction application is configured to generate object candidate data corresponding to one or more objects detected within captured images,
generate object identifier data for each object candidate in the object candidate data, and
transmit one or more of (i) the object candidate data or (ii) the object identifier data to the host device over the scanner terminal of the host device.

2. The data capture device of claim 1, further comprising an electronic weight scale connected to the imaging assembly, and wherein the computing instructions further cause the data capture device to:
detect, via the electronic weight scale, a change in weight of a display area, wherein the images are captured in response to the electronic weight scale detecting the change in weight, and the imaging assembly has a field of view of the display area.

3. The data capture device of claim 1, wherein the object prediction application is further configured to:
generate a confidence score for each object candidate in the object candidate data,
determine a greatest confidence score exceeds a second greatest confidence score by a threshold amount, and
generate determined object candidate data corresponding to the object candidate with the greatest confidence score, wherein object identifier data of the determined object candidate data is generated and the object identifier data of the determined object candidate data is transmitted to the host device.

4. The data capture device of claim 1, wherein:
a combination of the one or more processors and the one or more memories is separately housed from the imaging assembly and
the imaging assembly is communicatively connected to the host device via the scanner terminal.

5. The data capture device of claim 1, wherein:
a combination of the one or more processors and the one or more memories is separately housed from the imaging assembly and
the combination of the one or more processors and the one or more memories is communicatively connected to the host device via the scanner terminal.

6. The data capture device of claim 1, wherein:
the imaging assembly is housed in a same housing as the one or more processors and the one or more memories and
the data capture device is communicatively connected to the host device via the scanner terminal.

7. A computer-readable method comprising:
capturing, via an imaging assembly, images of an object in one or more fields of view,
wherein a data capture device decodes indicia on objects in image data and the data capture device transmits decoded indicia data to a host device over a scanner terminal of the host device;
in response to the data capture device being unable to identify a decodable indicia on the object, providing, via one or more processors of the data capture device, generated image data associated with the images to an object prediction application deployed on one or more memories of the data capture device;
identifying, via the object prediction application, one or more aspects of the object;
generating, via the object prediction application, object candidate data corresponding to the object from the identification,
wherein the object prediction application is configured to generate object candidate data corresponding to one or more objects detected within captured images;
generating, via the data capture device, object identifier data for each object candidate in the object candidate data; and
transmitting, via the data capture device, one or more of (i) the object candidate data or (ii) the object identifier data to a host device over the scanner terminal of the host device.

8. The computer-readable method of claim 7, further comprising:
detecting, via an electronic weight scale connected to the imaging assembly, a change in weight of a display area, wherein the images are captured in response to the electronic weight scale detecting the change in weight, and the imaging assembly has a field of view of the display area.

9. The computer-readable method of claim 7, wherein the object prediction application is configured to:
generate a confidence score for each object candidate in the object candidate data,
determine a greatest confidence score exceeds a second greatest confidence score by a threshold amount, and
generate determined object candidate data corresponding to the object candidate with the greatest confidence score, wherein an object identifier of the determined object candidate data is generated and the object identifier of the determined object candidate data is transmitted to the host device.

10. The computer-readable method of claim 7, wherein:
the one or more memories are communicatively coupled to the one or more processors,
the one or more processors are connected to the imaging assembly,
a combination of the one or more processors and the one or more memories is separately housed from the imaging assembly, and
the imaging assembly is communicatively connected to the host device via the scanner terminal.

11. The computer-readable method of claim 7, wherein:
the one or more memories are communicatively coupled to the one or more processors,
the one or more processors are connected to the imaging assembly,
a combination of the one or more processors and the one or more memories is separately housed from the imaging assembly, and
the combination of the one or more processors and the one or more memories is communicatively connected to the host device via the scanner terminal.

12. The computer-readable method of claim 7, wherein:
the one or more memories are communicatively coupled to the one or more processors,
the one or more processors are connected to the imaging assembly,
a data capture device comprises a combination of the one or more memories, the one or more processors and the imaging assembly,
the imaging assembly is housed in a same housing as the one or more processors and the one or more memories, and
the data capture device is communicatively connected to the host device via the scanner terminal.

13. A tangible, non-transitory computer-readable medium storing instructions that, when executed by one or more processors of a data capture device, cause the data capture device to:
capture, via the imaging assembly, images of an object in one or more fields of view,
wherein the data capture device decodes indicia on objects in image data and the data capture device transmits the decoded indicia data to a host device over a scanner terminal of the host device;
in response to being unable to identify a decodable indicia on the object, provide generated image data associated with the images to an object prediction application deployed on the one or more memories;
identify, via the object prediction application, one or more aspects of the object;
generate, via the object prediction application, object candidate data corresponding to the object from the identification,
wherein the object prediction application is deployed on the one or more memories and the object prediction application is configured to generate object candidate data corresponding to one or more objects detected within captured images;
generate object identifier data for each object candidate in the object candidate data; and
transmit one or more of (i) the object candidate data or (ii) the object identifier data to the host device over the scanner terminal of the host device.

14. The tangible, non-transitory computer-readable medium of claim 13, wherein the stored instructions further cause the data capture device to:
detect, via an electronic weight scale connected to the imaging assembly, a change in weight of a display area, wherein the images are captured in response to the electronic weight scale detecting the change in weight, and the imaging assembly has a field of view of the display area.

15. The tangible, non-transitory computer-readable medium of claim 13, wherein the object prediction application is configured to:
generate a confidence score for each object candidate in the object candidate data,
determine a greatest confidence score exceeds a second greatest confidence score by a threshold amount, and
generate determined object candidate data corresponding to the object candidate with the greatest confidence score, wherein an object identifier of the determined object candidate data is generated and the object identifier of the determined object candidate data is transmitted to the host device.

16. The tangible, non-transitory computer-readable medium of claim 13, wherein:
the one or more processors are connected to the imaging assembly,
a combination of the one or more processors and the tangible, non-transitory computer-readable medium is separately housed from the imaging assembly, and
the imaging assembly is communicatively connected to the host device via the scanner terminal.

17. The tangible, non-transitory computer-readable medium of claim 13, wherein:
the one or more processors are connected to the imaging assembly,
a combination of the one or more processors and the tangible, non-transitory computer-readable medium is separately housed from the imaging assembly, and
the combination of the one or more processors and the tangible, non-transitory computer-readable medium is communicatively connected to the host device via the scanner terminal.

18. The tangible, non-transitory computer-readable medium of claim 13, wherein:
the one or more processors are connected to the imaging assembly,
a data capture device comprises a combination of the tangible, non-transitory computer-readable medium, the one or more processors and the imaging assembly,
the imaging assembly is housed in a same housing as the one or more processors and the tangible, non-transitory computer-readable medium, and
the data capture device is communicatively connected to the host device via the scanner terminal.
